(19) United States
(12) Patent Application Publication
(10) Pub. No.: US 2016/0018995 A1
(43) Pub. Date: Jan. 21, 2016

(54) RAID SYSTEM FOR PROCESSING I/O REQUESTS UTILIZING XOR COMMANDS

(71) Applicant: LSI Corporation, San Jose, CA (US)

(72) Inventors: Naga Shankar Vadalamani, Bangalore (IN); Sridhar Rao Veerla, Bangalore (IN); Girish Dinne, Bangalore (IN)

(21) Appl. No.: 14/333,644

(22) Filed: Jul. 17, 2014

(51) Int. Cl. G06F 3/06; G06F 12/08

(52) U.S. Cl. CPC G06F 3/0619; G06F 12/0875; G06F 12/0866; G06F 3/0611; G06F 3/0656; G06F 3/0659; G06F 3/0689; G06F 2212/1032; G06F 2212/152; G06F 2212/202; G06F 2212/283; G06F 2212/312; G06F 2212/604; G06F 2212/70; G06F 2003/0691; G06F 2003/0692

(57) ABSTRACT

A controller for maintaining data consistency without utilizing region lock is disclosed. The controller is connected to multiple physical disk drives, and the physical disk drives include a data portion and a parity data portion that corresponds to the data portion. The controller can receive a first input/output command (I/O) from a first computing device for writing write data to the data portion and a second I/O command from a second computing device for accessing data from the data portion. The controller allocates a first buffer for storing data associated with the first I/O command and allocates a second buffer for storing data associated with a logical operation. The controller initiates a logical operation that comprises an exclusive OR operation directed to the write data and the read data to obtain resultant exclusive OR data and copies the write data to the data portion.

### FIELD OF THE DISCLOSURE

The present disclosure is directed to a redundant array of independent disks (RAID) system, and more particularly to a RAID system configured to maintain data consistency during simultaneous input/output commands (requests) to overlapping blocks of data.

### BACKGROUND

RAID systems comprise data storage virtualization technology that combines multiple disk drive components into a logical unit for the purposes of data redundancy and performance improvement. RAID systems can employ various configurations for storing and maintaining data redundancy. One of these configurations is referred to as RAID 5, and RAID 5 comprises block-level striping with distributed parity. The parity information is distributed among the drives that comprise the RAID 5 system.

### SUMMARY

A controller for maintaining data consistency without utilizing region lock is disclosed. In one or more embodiments, the controller is connected to multiple physical disk drives, and the physical disk drives include a data portion and a parity data portion that corresponds to the data portion. The controller can receive a first input/output command (I/O) from a first computing device for writing write data to the data portion and a second I/O command from a second computing device for accessing data from the data portion (e.g., another write operation, etc.). The I/O command and the second I/O command are for accessing the data portion simultaneously. The controller allocates a first buffer for storing data associated with the first I/O command and allocates a second buffer for storing data associated with a logical operation for maintaining data consistency. The controller initiates a logical operation that comprises an exclusive OR operation directed to the write data and the accessed data to obtain resultant exclusive OR data and copies the write data to the data portion and to cause the resultant exclusive OR data to be stored in the second buffer.

This Summary is provided to introduce a selection of concepts in a simplified form that are further described below in the Written Description. This Summary is not intended to identify key features or essential features of the claimed subject matter, nor is it intended to be used as an aid in determining the scope of the claimed subject matter.

### BRIEF DESCRIPTION OF THE FIGURES

The Written Description is described with reference to the accompanying figures. The use of the same reference numbers in different instances in the description and the figures may indicate similar or identical items.

FIG. 1 is a block diagram of a RAID system in accordance with an example embodiment of the present disclosure.

FIG. 2 illustrates multiple physical disk drives arranged in a RAID 5 configuration in accordance with an example embodiment of the present disclosure

FIG. 3 is a method diagram for processing a write request in accordance with an example embodiment of the present disclosure.

FIG. 4 is a method diagram for processing I/O commands in accordance with an example embodiment of the present disclosure.

FIG. 5 is a method diagram for processing removing data from cache buffers in accordance with an example embodiment of the present disclosure.

### WRITTEN DESCRIPTION

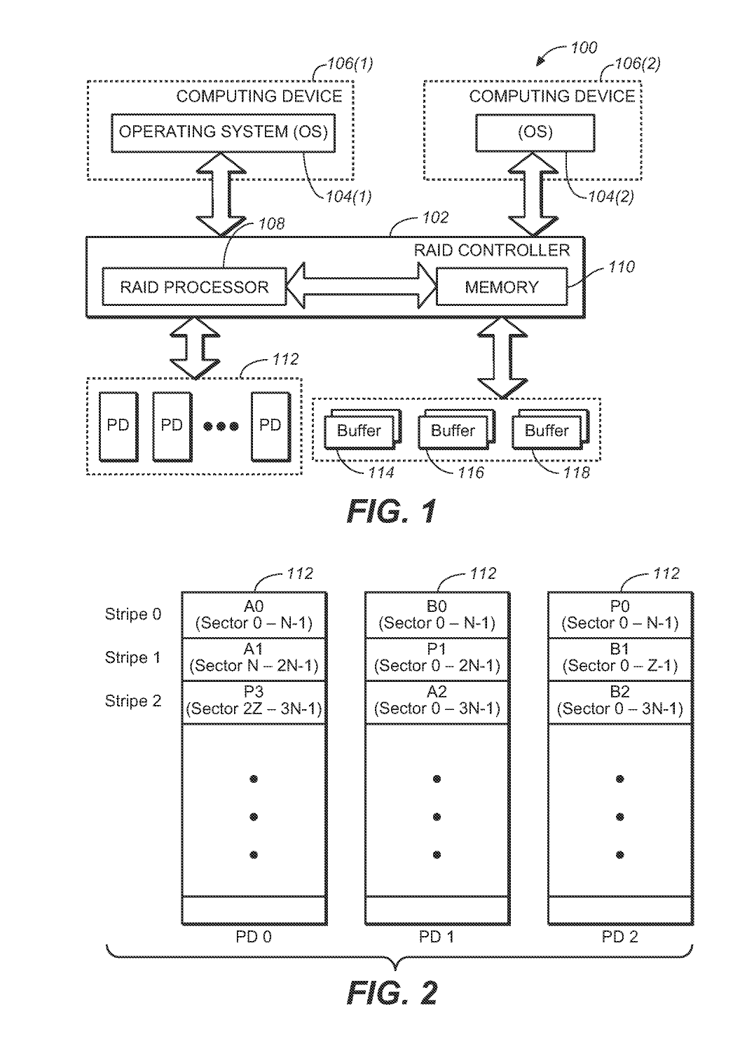

FIG. 1 illustrates a block diagram of a RAID system 100 in accordance with an example embodiment of the present disclosure. The RAID system 100 includes a RAID controller 102 receives input/output (I/O) commands from a first operating system (OS) 104(1) of a first computing device 106(1) (e.g., a first host) and a second operating system (OS) 104(2) of a second computing device 106(2). As the I/O commands are received in the RAID controller 102, the RAID processor 108 of the RAID controller 102 causes N of the I/O commands to be queued in a memory device 110 of the RAID controller 102. The memory device 110 may comprise nonvolatile memory devices, volatile memory devices, or the like.

As shown in FIG. 1, the RAID system 100 is communicatively connected to a plurality of physical disk drives (PDs) 112 to allow data to be distributed across multiple physical disk drives 112. In one or more embodiments of the present disclosure, the RAID system 100 employs a RAID 5 configuration for providing distributed parity. RAID 5 systems utilize striping in combination with distributed parity. The term “striping” means that logically sequential data, such as a single data file, is fragmented and assigned to multiple physical disk drives 112. For example, the data may be fragmented and assigned to multiple physical disk drives 112 utilizing round-robin techniques. Thus, the data is said to be “striped” over multiple physical disk drives 112 when the data is written. The term “distributed parity” means that the parity bits that are calculated for each strip of data are distributed over all of the physical disk drives 112 rather than being stored on one or more dedicated parity physical disk drives 112. Striping may improve performance because the data fragments that make up each data stripe are written in parallel to different physical disk drives 112 and read in parallel from the different physical disk drives 112. Distributing the parity bits also improves performance in that the parity bits associated with different data stripes can be written in parallel to different physical disk drives 112 using parallel write operations as opposed to having to use sequential write operations to a dedicated parity physical disk drive 112. As shown in FIG. 2, the physical disk drives 112 include data portions (e.g., regions A0, B0, A1, B1, . . . ) for storing data and parity data portions (e.g., regions P0, P1, . . . ) for storing parity data.

In one or more embodiments of the present disclosure, the system 100 utilizes Small Computer System Interface (SCSI) communication protocols. For example, the system 100 may utilize XDWRITEREAD command protocols, XPWRITE command protocols, and the like.

As shown, the RAID system 100 also includes multiple cache buffers 114, 116, 118, 116. In one or more embodiments of the present disclosure, the system 100 includes multiple buffers 114, buffers 116, buffers 118, and buffers 116. These buffers, as described in greater detail below, are utilized to store data associated with the physical disk drives 112. For instance, the buffer 114 may be a data buffer for storing data for a write back volume, the buffer 116 may be a parity buffer for storing parity data and/or resultant data of a logical operation (e.g., output data associated with an exclusive or operation), and the buffer 118 may be a temporary buffer for storing data and parity data. 116 116 The buffers 114, 116, 118 each have a respective buffer state for indicating the respective buffers availability. For instance, a buffer state can comprise “Not in use” to indicate that the buffer is not allocated. A buffer state can also comprise “Ready to use” to indicate the buffer is allocated and there is no operation pending. A buffer state can also comprise “Busy” indicating a read or write operation is in progress for the respective buffer and the buffer cannot be utilized (e.g., an XDWRITE or an XDWRITEREAD is in progress for the respective buffer). The buffer states can be maintained utilizing bits within the respective buffers 114, 116, 118. FIG. 2 illustrates an example logical volume of the physical disk drives 112 partitioned into data stripe regions and corresponding parity data regions in accordance with an example embodiment of the present disclosure. In an embodiment, the physical disk drives logical block addressing to specify the location of blocks of data stored within the physical disk drive.

As described herein in greater detail, the system 100 comprises a RAID controller 102 that maintains data integrity while processing simultaneous I/O requests (e.g., I/O requests issued to overlapping blocks of memory within the physical disk drives 112 at or near the same time) without utilizing region locks. For example, a first computing device 106 may issue an I/O request for accessing a first data stripe region, and a second computing device 106 may issue an I/O request for accessing the first data stripe region during the same time period of the I/O request from the first computing device 106. In some instances, based upon the I/O request, the corresponding parity data may need to be updated. In one or more embodiments of the present disclosure, the RAID controller 102 allocates a first data buffer 114 (and a first parity buffer 116) for the first I/O request issued from the first computing device 106 and allocates a second data buffer 114 (and a second parity buffer for the second I/O request issued from the second computing device 106.

The first data buffer 114 stores data associated with the first I/O request, and the second data buffer 114 stores data associated with the second I/O request. For instance, if the first I/O request is a read request, the first data buffer 114 stores the read data from the corresponding region in the physical disk drive 112. If the second I/O request is a write request, the second data buffer 114 stores the write data for the corresponding region in the physical disk drive 112. In this instance, the data is consistent independent which direct memory access (DMA) command (e.g., read command or write command) completes first.

In an embodiment of the present disclosure, the RAID controller 102 receives a write request from a computing device 102 (e.g., a host). The RAID controller 102 allocates a data buffer (e.g., a buffer 114) and a buffer for storing data associated with a logical operation (e.g., a buffer 116) in response to receiving the write request. The RAID controller 102 may copy the write data (e.g., data to be written per the write request) to the data buffer utilizing direct memory access protocols. The RAID controller 102 can then initiate a logical operation. For instance, the RAID controller 102 issues an XDWRITEREAD command to the corresponding data region of the physical disk drive 112 for the accessed stripe region (e.g., writes the data write data to the data region with the source buffer indicated as the data buffer and the destination buffer as the exclusive OR buffer). The source and the destination buffer address are provided utilizing the XDWRITEREAD command such that the resultant XOR data generated by the memory device or physical disk drive can be copied to the destination buffer. Utilizing an XPWRITE command, the RAID controller 102 writes the resulting data to the corresponding parity data region in the physical disk drive 112. Thus, the RAID system 100 is configured to maintain parity data consistency without utilizing region locks.

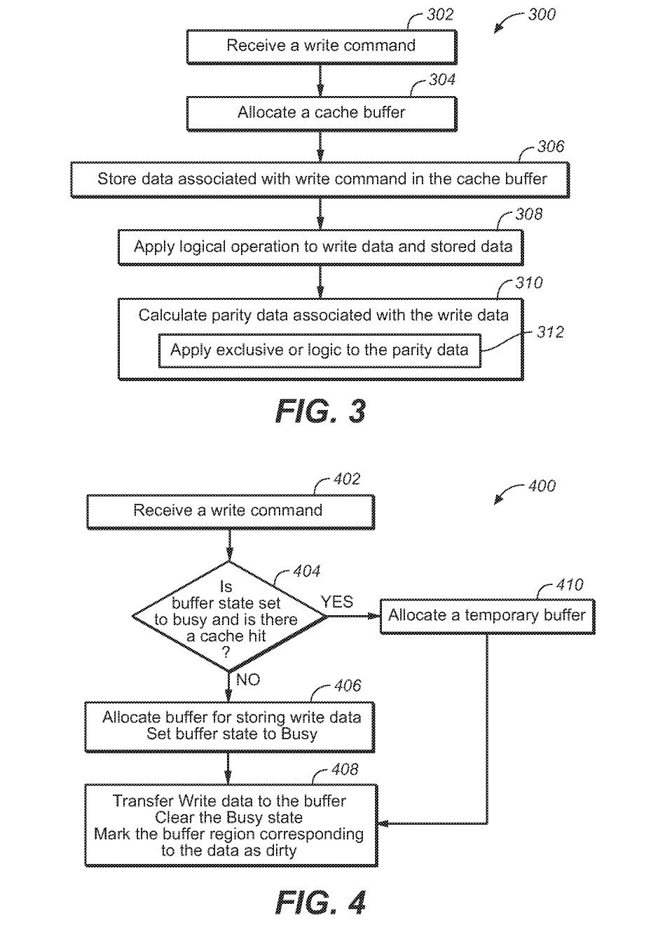

FIG. 3 illustrates an example method 300 for processing a write request for a write through procedure in accordance with an example embodiment of the present disclosure. As shown, a write command (e.g., write command) is received (Block 302). In an embodiment, the RAID controller 102 receives a write command from the computer 106 for writing data to one or more physical disk drives 112. Based upon the write command, a cache buffer is allocated (Block 304). In an embodiment, the RAID controller 102 allocates a buffer 114 for storing data provided by the computer 106 and a buffer 116 for storing logical operation data. The buffer state of the buffer 116 is marked to indicate that it is in use (e.g., a busy state). The data associated with the write command is stored in the cache buffer (Block 306). For example, the RAID controller 102 may initiate a direct memory access (DMA) to store the write data into the buffer 114 from the computing device 102. As shown in FIG. 3, a logical operation is performed on the write data and the stored data (Block 308). In an embodiment of the present disclosure, the RAID controller 102 initiates a logical operation that causes the plurality of physical data drives 112 to perform an exclusive OR operation between the write data and the read data (e.g., outputs a logic true whenever the corresponding data of the write data and the read data differ). In this embodiment, the source buffer comprises the data buffer 114 and the destination buffer comprises the exclusive OR data buffer 116.

As shown in FIG. 3, parity data associated with the write command data is calculated (Block 310) once the resultant exclusive OR data is copied to the physical data drive. For example, the logical operation is applied to the respective parity data (Block 312). In one or more embodiments, an XPWRITE command is issued, and the RAID controller 102 initiates an exclusive OR logical operation to the parity data associated with the write data and the parity data associated with the read data, and the resulting data is stored in the buffer 116. The parity data, once the parity data is calculated, is stored in the corresponding regions of the physical disk drives (e.g., parity regions associated with the write command data). As shown in FIG. 3, the cache buffer is invalidated (Block 314). Once the parity data has been written to the physical disk drives 112, the RAID controller 102 invalidates the buffer 114. For example, the RAID controller 102 causes the state of the buffers 114, 116, 118 to transition to “Not in use,” indicating the respective buffer 114, 116, 118 is not allocated. The RAID controller 102 can provide a communication to the computing device 106 that the write command is completed.

FIG. 4 illustrates a method 400 for processing a write request for a write back procedure in accordance with an example embodiment of the present disclosure. As shown, a write command is received (Block 402). For example, a write command is received at the RAID controller 102 from the computing device 106. The write command comprises a command to write data to a region within the physical disk drives 112. A determination of whether a buffer state is busy made (Decision Block 404). In an embodiment, the RAID controller 102 determines whether a cache hit occurred and the state of buffer state of a respective buffer 114 for storing the write data associated with the write command. If the buffer state of the buffer is not busy and there was a cache hit (NO from Decision Block 404), the buffer is allocated for the storing the write data (Block 406). For example, when the RAID controller 102 determines the buffer state of the buffer 114 is not busy and there was a cache hit, the RAID controller 102 allocates the buffer 114. The buffer state of the buffer is marked (e.g., set) to indicate that it is in use (e.g., set to a busy state). The write data is transferred to the buffer (Block 408). For example, the RAID controller 102 initiates a direct memory access protocol to cause the write data associated with the write command to be stored in the buffer 114. After the host data is copied to the buffer 114, the buffer state of the buffer 114 is cleared to indicate that it is not in use The RAID controller 102 then indicates to the computing device 106 that the write command is complete.

If the buffer state of the buffer is busy and there was a cache hit (YES from Decision Block 404), a temporary buffer is allocated (Block 410). For example, when the RAID controller 102 determines the buffer state of the buffer 114 is busy and there was a cache hit, the RAID controller 102 allocates a temporary buffer 118 (e.g., a second buffer), and the RAID controller 102 links the temporary buffer 118 with the buffer 114. The write data is transferred to the buffer (Block 408). For example, the RAID controller 102 utilizes direct memory access protocols to cause the write data associated with the write command to be stored in the buffer 118. The RAID controller 102 then indicates to the computing device 106 that the write command is complete.

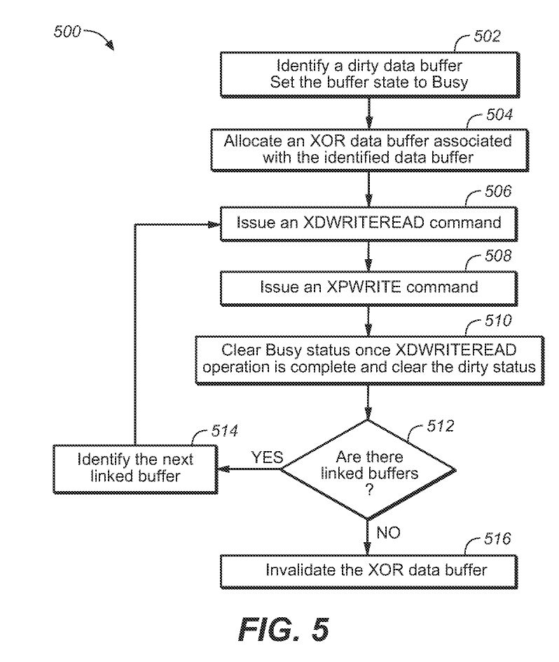

FIG. 5 illustrates a method 500 for removing (e.g., flushing) data from the cache buffers, such as the buffers 114, 116, 118, 116. As shown in FIG. 5, a dirty data buffer is identified (Block 502). In an embodiment of the present disclosure, the RAID controller 102 identifies a cache buffer (e.g., buffer 114, 116, 118) that is indicated as dirty (e.g., buffers identified as containing host data that is not committed to the drives 112/memory devices, etc.) and that is not currently in use [e.g., the buffer state is indicated as not busy]). Once a dirty data buffer is identified, the buffer state is updated to indicate that it is in use and the XOR cache buffer associated with the identified data buffer is allocated (Block 504). The RAID controller 102 allocates a XOR buffer 116 that is associated with the identified buffer. As shown in FIG. 5, a XDWRITEREAD command is issued (Block 506). For example, an XDWRITEREAD command is issued to the respective physical disk drive 112 with the source address representing the data buffer address and the destination address representing the exclusive OR buffer address. The aforementioned operation would indicate to the drive 112 (or a memory device) to initiate a read operation to read the data from the identified portions of the physical disk drive 112 and writes the write data to the identified portion of the physical disk drive, as well asto perform a logical XOR operation on the old and the new data and transfer the resultant data to the destination exclusive OR buffer address (e.g., buffer 116). As shown, an XPWRITE command is issued (Block 508). The RAID controller 102 issues a command (e.g., an XPWRITE command) to initiate a logical operation (e.g., an exclusive OR operation) of the new XOR data and the previous parity data stored within the physical disk drives 112 with the resulting data is stored in a respective buffer 116. For example, the RAID controller 102 issues an XPWRITE command directed to the parity drive portion of the physical disk drive 112 such that the XOR data stored in the buffer 116 is stored in the corresponding parity drive portion. The buffer states associated with this data are cleared (e.g., clear busy status) once the XDWRITEREAD operation is complete. The dirty status is also cleared for these buffers.

A determination of whether linked buffers exist occurs (Decision Block 510). The RAID controller 102 then determines whether linked buffers (e.g., data buffers) exist. Linked buffers comprise buffers that contain data for the same data portion within the physical disk drives 112. If linked buffers exist (YES from Decision Block 510), the next linked buffer is identified (Block 512). For example, the RAID controller 102 identifies the next linked buffer (e.g., linked buffer 114), which, as described above, is flushed. If there is no linked buffers (NO from Decision Block 510), the exclusive or buffer is invalidated (Block 516). For instance, the RAID controller 102 invalidates the respective buffer 116 when the data stored in the buffer 116 has been stored in the corresponding parity drive portion of the physical disk drive. The RAID controller 102 determines whether there are any remaining dirty data buffers to be flushed. If there are remaining the data buffers to be flushed, the next dirty data buffer is identified, and, as described above, is flushed. While the present disclosure discusses utilization of specific SCSI commands (e.g., XDWRITEREAD and XPWRITE), it is understood that other commands representing the same functionality may be utilized without departing from the spirit of the disclosure.

Generally, any of the functions described herein can be implemented using hardware (e.g., fixed logic circuitry such as integrated circuits), software, firmware, manual processing, or a combination of these embodiments. Thus, the blocks discussed in the above disclosure generally represent hardware (e.g., fixed logic circuitry such as integrated circuits), software, firmware, or a combination thereof. In the instance of a hardware embodiment, for instance, the various blocks discussed in the above disclosure may be implemented as integrated circuits along with other functionality. Such integrated circuits may include all of the functions of a given block, system or circuit, or a portion of the functions of the block, system or circuit. Further, elements of the blocks, systems or circuits may be implemented across multiple integrated circuits. Such integrated circuits may comprise various integrated circuits including, but not necessarily limited to: a monolithic integrated circuit, a flip chip integrated circuit, a multichip module integrated circuit, and/or a mixed signal integrated circuit. In the instance of a software embodiment, for instance, the various blocks discussed in the above disclosure represent executable instructions (e.g., program code) that perform specified tasks when executed on a processor. These executable instructions can be stored in one or more tangible computer readable media. In some such instances, the entire system, block or circuit may be implemented using its software or firmware equivalent. In other instances, one part of a given system, block or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a controller configured to operatively couple to a plurality of physical disk drives, the plurality of physical disk drives including a data portion and a parity data portion, the parity data portion corresponding to the data portion,
the controller configured to receive a first input/output command from a first computing device for writing write data to the data portion and a second input/output command from a second computing device for accessing data stored in the data portion, the first input/output command and the second input/output command for accessing the data portion simultaneously, the controller configured to allocate a first buffer for storing data associated with the first input/output command and to allocate a second buffer for storing data associated with a logical operation for maintaining data consistency, the controller configured to initiate a logical operation comprising an exclusive OR operation directed to the write data and the accessed data to obtain resultant exclusive OR data, the controller configured to cause the write data to be copied to the data portion and to cause the resultant exclusive OR data to be stored in the second buffer.

2. The apparatus as recited in claim 1, wherein the accessed data portion includes parity data associated with the accessed data, the controller configured to initiate the logical operation directed to the accessed parity data and the resultant exclusive OR data to obtain a resultant exclusive OR parity data, the controller configured to cause the resultant exclusive OR parity data to be copied to the parity data portion.

3. The apparatus as recited in claim 1, wherein the controller is configured to allocate a XOR buffer for storing exclusive OR data.

4. The apparatus as recited in claim 3, wherein the controller is configured to cause the resultant exclusive OR parity data to be copied from the exclusive OR buffer to the parity portion utilizing an XPWRITE command.

5. The apparatus as recited in claim 1, wherein the controller is configured to initiate the logical operation directed to the write data and the read data utilizing an XPWRITEREAD command.

6. The apparatus as recited in claim 1, wherein the first buffer and the second buffer include a buffer state portion for indicating a buffer state.

7. The apparatus as recited in claim 7, wherein the controller is configured to determine a buffer state of the first buffer and the second buffer before allocating the first buffer and the second buffer.

8. A system comprising:
a plurality of physical disk drives, the plurality of physical disk drives including a data portion and a parity data portion, the parity data portion corresponding to the data portion;
a controller operatively coupled to the plurality of physical disk drives, the controller configured to receive a first input/output command from a first computing device for writing write data to the data portion and a second input/output command from a second computing device for accessing data stored in the data portion, the first input/output command and the second input/output command for accessing the data portion simultaneously, the controller configured to allocate a first buffer for storing data associated with the first input/output command and to allocate a second buffer for storing data associated with a second logical operation for maintaining data consistency, the controller configured to initiate a logical operation comprising an exclusive OR operation directed to the write data and the accessed data to obtain resultant exclusive OR data, the controller configured to cause the write data to be copied to the data portion and to cause the resultant exclusive OR data to be stored in the second buffer.

9. The system as recited in claim 8, wherein the accessed data portion includes parity data associated with the accessed data, the controller configured to initiate the logical operation directed to the accessed parity data and the resultant exclusive OR data to obtain a resultant exclusive OR parity data, the controller configured to cause the resultant exclusive OR parity data to be copied to the parity data portion.

10. The system as recited in claim 9, wherein the controller is configured to allocate a exclusive OR buffer for storing exclusive OR data, the controller configured to store at least one of the resultant exclusive OR data or the resultant exclusive OR parity data in the exclusive OR buffer.

11. The system as recited in claim 10, wherein the controller is configured to cause the resultant exclusive OR parity data to be copied from the exclusive OR buffer to the parity portion utilizing an XPWRITE command.

12. The system as recited in claim 8, wherein the controller is configured to initiate the logical operation directed to the write data and the read data utilizing an XPWRITEREAD command.

13. The system as recited in claim 8, wherein the first buffer and the second buffer include a buffer state portion for indicating a buffer state.

14. The system as recited in claim 13, wherein the controller is configured to check the buffer state of the first buffer and the second buffer before allocating the first buffer and the second buffer.

15. The system as recited in claim 8, wherein the plurality of physical disk drives are organized in a RAID 5 configuration.

16. A method comprising:
receiving a write command from a computing device for writing write data to a data portion, the data portion stored in at least one physical disk drive of a plurality of physical disk drives, wherein at least another one of the plurality of physical disk drives includes a parity data portion corresponding to the data portion;
allocating a first buffer for storing the write data;
allocating a second buffer for storing data resulting from an logical operation comprising an exclusive OR operation;
obtaining read data stored in the data portion;
initiating a logical operation comprising an exclusive OR operation directed to the write data and the read data to obtain resultant exclusive OR data; and
causing the resultant exclusive OR data to be copied to the second buffer.

17. The method as recited in claim 16, further comprising causing the resultant exclusive OR data to be copied to the parity data portion utilizing an XPWRITE command.

18. The method as recited in claim 16, further comprising setting a buffer state of the buffer to indicate the buffer is in use when the buffer is allocated; invalidating the buffer when the resultant exclusive OR data is copied to the parity portion, and setting the buffer state to not in use when the buffer is unallocated.

19. The method as recited in claim 16, further comprising causing the write data to be copied to the data portion and copy the resultant exclusive OR data to the second buffer utilizing an XDWRITEREAD command.

20. The method as recited in claim 16, wherein the plurality of physical disk drives are organized in a RAID 5 configuration.
